(19) United States
(12) Patent Application Publication
(10) Pub. No.: US 2011/0090705 A1
(43) Pub. Date: Apr. 21, 2011

(54) LUMINAIRE REFLECTOR

(75) Inventors: Dieter HACKFORT, Duisburg (DE); Ioannis LAFTSIDIS, Wuppertal (DE); Andreas MOCKING, Schwelm (DE)

(73) Assignee: JORDAN REFLEKTOREN GMBH & CO. KG, Wuppertal (DE)

(21) Appl. No.: 12/813,898

(22) Filed: Jun. 11, 2010

(30) Foreign Application Priority Data
Oct. 16, 2009 (EP) 09173309.7
Apr. 9, 2010 (DE) 20 2010 004 806.0

(51) Int. Cl. F21V 7/00

(52) U.S. Cl. 362/347

(57) ABSTRACT

A luminaire reflector composed of a pot-like hollow, rotationally symmetrical, frustoconical reflector body having a peripheral wall that is circularly curved in a peripheral direction and increases in diameter from a rear side up to a front light exit opening is provided. The reflector body has an outwardly bent over, annular peripheral edge web that surrounds the light exit opening and is bounded by two circles of different radii. The peripheral wall of the reflector body is longitudinally divided into two to four shell-like wall parts correspondingly curved in the shape of a circular arc in a peripheral direction, or the peripheral may be formed from one piece. Each wall part, or the unitary peripheral wall, together with a part of the annular peripheral edge web, is formed from a pre-coated sheet metal material that is strongly optically reflecting at least on the inside.

### CROSS REFERENCE TO RELATED APPLICATIONS

This application claims priority to German patent application no. 20 2010 004 806.0, filed on Apr. 9, 2010, and to European patent application no. 09173309.7, filed on Oct. 16, 2009, the contents of which are incorporated by reference in their entireties.

### FIELD OF THE INVENTION

The present invention relates to reflectors, and more particularly, to luminaire reflectors of the type commonly used in ceilings.

### BACKGROUND OF THE INVENTION

Reflectors, frequently also termed downlight reflectors or floods, are installed, for example, in or on ceilings such that they lie with their front light exit opening substantially in or parallel to the ceiling plane. The peripheral edge web usually lies likewise in the plane of the light exit opening.

Known reflectors are usually produced in one piece in a rotationally symmetrical fashion from an originally flat sheet metal blank in a forming operation. This is associated with a very high outlay. Moreover, this design has the disadvantage that such reflectors cannot be surface coated, for example metalized, until after forming, a nonoptimum reflection efficiency thereby being achieved as a rule.

Other reflectors are assembled from a plurality of different parts, the different parts respectively being bent from an already precoated flat sheet metal material. However, these multipartite reflectors have, on the one hand, an appearance deviating substantially from a rotationally symmetrical reflector shape and, on the other hand, a very poor mechanical stability, particularly in the region of the light exit opening, because of a lack of a peripheral edge web.

Document US 2006/0193151 A1 describes a reflector whose reflector body is composed of a multiplicity of parts, specifically eight parts, to be precise. These individual segment-like and/or facet-like reflector parts have a specific curvature between the reflector rear side and the light exit opening (outwardly convex and inwardly concave), but are of rectilinear design in a peripheral direction. This holds, in particular, for the side of the light exit opening, since a strip-shaped, narrowly rectangular edge here adjoins each part via a rectilinear bending line. Owing to this configuration, in cross section and in the region of the light exit opening the reflector has in practice a polygonal shape such that it is not rotationally symmetrical.

Further document U.S. Pat. No. 4,242,727 also describes a multipartite, nonrotationally symmetrical reflector.

The publication DE 20 2006 003 988 U1 describes a luminaire having a reflector composed of a plurality of reflector segments. Here, again, what is involved is a very large number of reflector segments, specifically twelve segments, that are mounted via additional holding elements (lower holding ring and cover plate). Here, as well, the individual segments are of rectilinear design in a peripheral direction, and therefore not rotationally symmetrical. To this extent, a polygonal cross-sectional shape also results here.

A further reflector, described in document US 2002/0109983 A1, is composed of an outer hollow body as carrier and a plurality of inner reflector parts that are inserted in receptacles on the inside of the carrier. In the case of this reflector, as well, the inner reflector parts are rectilinear in a peripheral direction, and so a polygonal, nonrotationally symmetrical shape results.

The publication US 2002/0071280 A1 describes a reflector divided into two halves, with casting molding parts with relatively large wall thickness being involved. No front peripheral edge web is present.

Finally, U.S. Pat. No. 6,152,583 describes a unipartite reflector that has regions with different reflection properties in a peripheral direction.

### SUMMARY OF THE INVENTION

In one aspect of the present invention, a luminaire reflector is provided that can be produced easily and cost-effectively, and that also ensures a high reflection efficiency in conjunction with high mechanical stability.

In a first variant in accordance with the invention, the peripheral wall of the reflector body is longitudinally divided into two to four shell-like wall parts, each wall part being formed with a defined curvature, which is correspondingly in the shape of a circular arc in a peripheral direction, and, together with a part of the annular peripheral edge web, in one piece from a surface pre-coated that is sheet metal material strongly optically reflecting. The wall parts may be permanently interconnected in the region of longitudinally running parting lines. To this end, the wall parts preferably have, in the region of the parting lines, radially outwardly bent over connecting webs that are interconnected in each case in pairs in juxtaposed fashion, in particular via clinch joints or such point connections. In this embodiment, each wall part therefore forms a part of the peripheral wall, which is circularly curved in a peripheral direction, and so the rotationally symmetrical appearance is advantageously retained. The inner surface of the reflector is interrupted only by the longitudinally running parting lines, which are scarcely visible, however. A high mechanical stability of the reflector is also achieved in the region of the light exit opening, because of the mechanically very firm connection of the wall parts, and also owing to the bent over, overall annular peripheral edge web that preferably lies in the plane defined by the light exit opening. In this embodiment, for each wall part, the section of the peripheral edge web is of annular design despite the unipartite forming of the originally flat sheet metal material, a bending line running in the shape of a circular arc between the wall part and the web section with a first radius of curvature. On the outside, the peripheral edge web preferably has a likewise circular outer edge with a second, larger radius of curvature.

In another variant of the invention, it is provided that the peripheral wall of the reflector body is continuously longitudinally divided only at one peripheral site with the formation of a parting line and therefore is composed of only one wall part, whose longitudinal edges are permanently connected in the region of the parting line, and that is formed in one piece, with a defined circular curvature in peripheral terms and together with the annular peripheral edge web, from a pre-coated sheet metal material that is strongly optically reflecting at least on the inside. Here, the rotationally symmetrical appearance is scarcely impaired, because the reflector inner surface has only one parting line, which is scarcely visible as a thin, linear “seam”. However, the same advantages are achieved as in the case of the two- to four-part design.

Because of the inventive refinement, each wall part can advantageously be cut to size from a precoated flat sheet metal material, and be formed in a rotationally symmetrical fashion (with reference to the finished, assembled reflector body) by a bending process with the application of pressure. In addition, the part of the peripheral edge web that corresponds to the periphery of the wall part, as well as the connecting webs, are also respectively formed. A high light efficiency is achieved by the use of the precoated material.

In another embodiment of the invention, the reflector body is closed by a cover on its rear side, which lies opposite the light exit opening and has a smaller diameter. The cover can advantageously be connected to the reflector body via latching connections. To this end, each wall part of the reflector body may have connecting lugs at the edge, which are distributed over the periphery and are plugged through slot apertures of the cover and then deformed, specifically radially inwardly or outwardly bent over or twisted, in particular. Even in this region opposite the light exit opening the cover lends the reflector body a very high stability, and thereby provides the entire reflector body with its precise basic shape.

Just like the reflector body, the cover also consists of a sheet metal material that is strongly optically reflecting at least on the inside, in particular of a reflectingly coated aluminum metal sheet. A particularly suitable material is available under the designation “MIRO” (registered trademark of ALANOD Aluminium-Veredlung GmbH and Co. KG). Here, the sheet metal material can have a smooth, high-gloss surface or a surface with facet-like profiles, but likewise high-gloss.

Owing to the at least bipartite to at most quadripartite design of the peripheral wall of the reflector body, there is the advantageous possibility of forming the wall parts with different surfaces. It is possible hereby to achieve an asymmetric reflection effect, in particular. For example, in the case of a tripartite design of the peripheral wall only one of the wall parts can have a surface with facet-like profiles, while the remaining wall parts have smooth, high-gloss surfaces. However, this can also be provided in the opposite way.

### BRIEF DESCRIPTIONS OF THE DRAWINGS

The drawings described herein are for illustration purposes only and are not intended to limit the scope of the present disclosure in any way.

FIG. 1 shows a perspective view of an inventive reflector in a first design, in accordance with the principles of the present invention;

FIG. 2 shows a side view in the direction of the arrow II in accordance with FIG. 1;

FIG. 3 shows a plan view of the rear side in the direction of the arrow III in accordance with FIG. 2;

FIG. 4 shows an illustration as in FIG. 1 of a second embodiment of the inventive reflector, in accordance with the principles of the present invention;

FIG. 5 shows a side view in the direction of the arrow V in accordance with FIG. 4;

FIG. 6 shows a plan view in the direction of the arrow VI in accordance with FIG. 5 by analogy with the illustration in FIG. 3;

FIG. 7 shows a further illustration as in FIGS. 1 and 4 in an advantageous refinement of the inventive reflector;

FIG. 8 shows a plan view of the rear side in the direction of the arrow VIII in accordance with FIG. 7;

FIG. 9 shows a simplified, schematic longitudinal diametral section in the plane IX-IX in accordance with FIG. 8,

FIG. 10 shows a further illustration as in FIGS. 1, 4 and 7 in a particularly advantageous embodiment of the inventive reflector;

FIG. 11 shows a side view in the direction of the arrow XI in accordance with FIG. 10; and

FIG. 12 shows a plan view of the rear side in the direction of the arrow XII in accordance with FIG. 11.

Like parts in the various figures are provided with like reference numerals.

### DETAILED DESCRIPTIONS OF THE INVENTION

Referring now the Figures, an embodiment of an inventive luminaire reflector illustrated at 1. The luminaire reflector 1 is composed of a hollow, substantially frustoconical and largely rotationally symmetrical reflector body 2 having a peripheral wall 6 that proceeds from a rear side 3 up to a front light exit opening 4 with a diameter that increases, in particular, conically.

The term “conical” or “substantially frustoconical” means, however, that the peripheral wall 6—which is circularly curved in a peripheral direction and therefore rotationally symmetrical—of the reflector body 2 can in principle also be designed to be cambered in a longitudinal direction between the rear side 3 with the smaller diameter and the larger light exit opening 4, for example to be cambered convexly outward and thus concavely on the inside. In addition, the reflector body 2 has a peripheral edge web 12 that surrounds the light exit opening 4, is bent over outwardly and is annular and aligned in accordance with the plane of the light exit opening 4.

It may be remarked that the term “frustoconical” encompasses those designs where the peripheral wall of the reflector body that is circular in a peripheral direction and therefore rotationally symmetrical is also designed to be at least weakly cambered, seen in a longitudinal direction, in particular to be cambered convexly outward and thus, for example, to be approximately parabolic. In addition, the term “rotationally symmetrical” includes the fact that the reflector can deviate slightly from an exactly rotationally symmetrical shape—for example through having a facet-like surface structure.

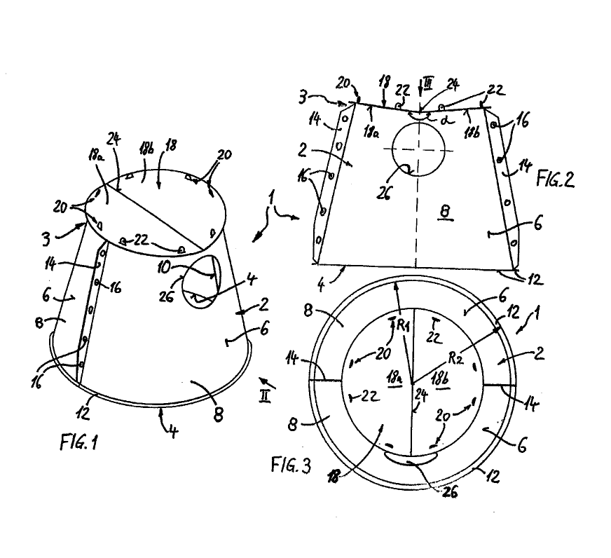

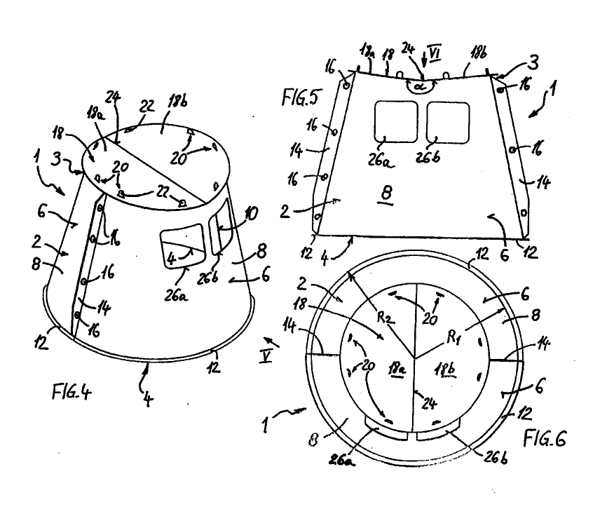

According to an embodiment of the invention, in the designs in accordance with FIGS. 1 to 9, the reflector body 2 is subdivided in a longitudinal direction between the rear side 3 and light exit opening 4 into at least two to at most four wall parts 8. Consequently, a longitudinally running parting line 10 is formed in each case between two neighboring wall parts 8 in a peripheral direction (see FIGS. 1, 4 and 7). Here, the peripheral edge web 12 is in each case partly a unipartite, formed component of the respective wall part 8. The edge web 12 is, nevertheless, of annular design overall and lies exactly or at least approximately in the plane defined by the light exit opening 4 (FIGS. 2, 5 and 9). As emerges from each of the FIGS. 3, 6 and 8, the peripheral edge web 12—and thus also every edge web section of the respective wall part 8—is bounded radially on the inside by a bending line in the shape of a circular arc and having a first, smaller radius of curvature R₁, and on the outside by an outer edge, preferably likewise in the shape of a circular arc, with a second, larger radius of curvature R₂.

The wall parts 8 are permanently interconnected in the region of the parting lines 10 via connecting webs 14 that are bent over radially outward and run in a longitudinal direction of the peripheral wall 6. The connecting webs 14 are preferably undetachably interconnected in pairs in a flat, juxtaposed fashion via point connections 16, specifically via so-called clinch joints, in particular. Alternatively, a connection can also be made via riveted joints or else spot welds.

The point connections 16 are arranged in a fashion distributed over the length of the connecting webs 14. The number of the required point connections 16 depends on the length of the connecting webs 14 and/or the height of the reflector body 2. As a rule, three to five point connections 16 suffice in order to connect two connecting webs 14 in each case.

In the designs illustrated in FIGS. 1 to 9, the peripheral wall 6 of the reflector body 2 is composed of only two wall parts 8 extending over 180° of the periphery, which are similar and therefore in the shape of half shells. The connecting webs 14 in this case define a diametral parting plane of the reflector body 2.

Alternatively, however, the peripheral wall 6 can also be composed of three or four wall parts 8 preferably having a radially symmetrical division such that each wall part 8 then extends over a peripheral angle of 120° or 90°.

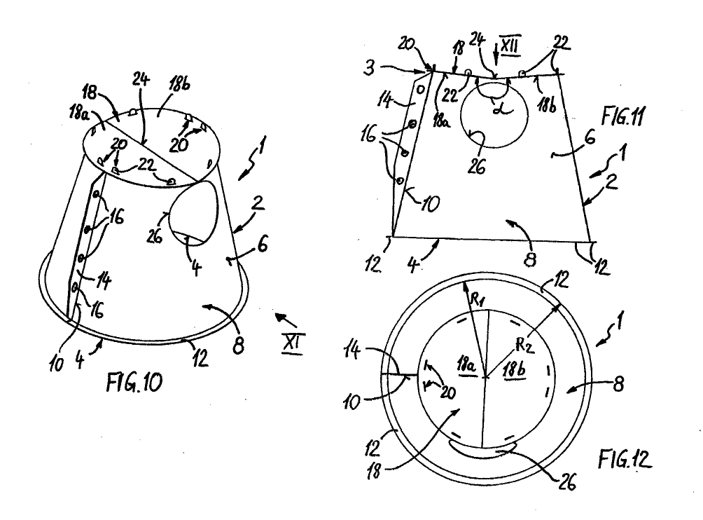

Turning now to the design in accordance with FIGS. 10 to 12, here the peripheral wall 6 is composed only of one wall part 8 by virtue of the fact that the peripheral wall 6 is longitudinally divided at only one site on its circular periphery of 360° with the formation of a parting line 10. The wall part 8 is formed in a peripheral direction with a defined circular shape and, together with the complete annular peripheral edge web 12, in one piece from the specific precoated sheet metal material already mentioned. On both sides of the parting line 10, the wall part 8 respectively has a connecting web 14. These two connecting webs 14 are permanently interconnected in the way already described.

In the illustrated designs, the peripheral edge web 12 is subdivided via a radial parting gap in an extension of each parting line 10.

Each wall part 8 has a pronounced circular curvature in a peripheral direction, specifically also in the region of the bending line (radius R₁) in the transition to the respective section of the peripheral edge web 12.

In the case of the preferred designs illustrated, the reflector body 2 is closed by a cover 18 on its rear side 3, which lies opposite the light exit opening 4 and has a minimum diameter. The cover 18 is advantageously connected to the reflector body 2 via latching connections 20. To this end, each wall part 8 of the reflector body 2 has connecting lugs 22 at the edge that are formed as unipartite extensions, are arranged in a fashion distributed over the periphery and are plugged through slot apertures (not denoted) of the cover 18 and then formed such that they fix the cover 18 on the reflector body 2. The connecting lugs 22 are preferably bent over radially inward or outward, but they can also merely be twisted about their longitudinal axes.

In a further preferred refinement, the cover 18 is subdivided into two partial surfaces 18a and 18b via a diametrically running bending line 24. On the one hand, this feature also contributes to increased stability. On the other hand, this configuration of the cover 18 influences the reflection properties of the inventive reflector 1. To this end, the partial surfaces 18a and 18b are aligned on the inside of the reflector body 2 at an angle α to one another that is greater than 180°. Reference is made in this context to the illustrations in FIGS. 2 and 5, in particular. The angle α preferably lies in the range from 190° to 210°. Owing to this configuration, the cover 18 reflects the light at least of one luminous means (not illustrated) obliquely to the side in the direction of the peripheral wall 6.

In the case of the designs illustrated, the bending line 24 of the cover 18 runs perpendicular to the diametral parting plane of the reflector body 2, which lies between the two wall parts 8.

As an alternative to the designs illustrated, the cover 18 can also be composed of two partial surfaces that enclose an angle α<180° in the interior of the reflector body 2. In addition, the cover 18 can also be subdivided into more than two partial surfaces, neighboring partial surfaces possibly being aligned at any desired angle α≠180° to one another.

In the vicinity of the rear side 3 with the smaller diameter, that is to say in the vicinity of the cover 18, the peripheral wall 6 of the reflector body 2 has at least one through opening 26 for a luminous means. In the case of the designs in accordance with FIGS. 1 to 3 and 7 to 9, an individual through opening 26 is arranged in the middle, seen in a peripheral direction, in one of the two wall parts 8 of the reflector body 2, and specifically symmetrically relative to a diametral middle plane, defined by the bending line 24, of the reflector body 2. The individual through opening 26 (cf. also FIGS. 10 to 12) is of circular design, in particular. A luminous means (not illustrated) can be inserted into the reflector body 2 through the through opening 26. The light thereof is then reflected by the cover 18 and the peripheral wall 6, and exits through the light exit opening 4.

In the design variant in accordance with FIGS. 4 to 6, two through openings 26a and 26b for in each case one luminous means are arranged symmetrically in a peripheral direction in the wall part 8, and symmetrically in relation to the bending line 24. Here, the through openings 26a, b can respectively be of approximately rectangular design.

In the design variants not illustrated, the cover 18 can also be of flat design (without bend). In addition, at least one luminous means through opening can be provided in the region of the cover 18 instead of in the peripheral wall 6. As in the illustration, the cover 18 can have a circular outer edge, but it can also have another, for example polygonal (such as octagonal, planar shape).

In addition, the cover 18 can also have suitable holding elements, for example ones that are integrally formed in one piece and/or fastened, for any desired components (for example a luminaire mount) and/or for mounting the reflector body 2 inside a luminaire or a luminaire housing.

It may be remarked in addition that the luminous means through opening of the peripheral wall 6 and/or the cover 18 can be designed with any desired opening shape specific to the luminous means.

The reflector body 2 and, preferably, also the cover 18, may consist of a sheet metal material that is strongly optically reflecting at least on the inside, in particular of a reflectingly coated aluminum metal sheet. In this case, the sheet metal material can have a smooth surface or one that has facet-like profiles but is in any case high-gloss and metalized in practical terms.

The sheet metal material preferably used can have a thickness in the range of 0.2 to 0.8 mm, in particular 0.4 to 0.5 mm. The reflector 1 can be designed with virtually any desired dimensions and size ratios, for example with an axially measured height in the range of 100 to 200 mm (in particular 120 to 160 mm), a maximum diameter in the range of 150 to 250 mm and a minimum diameter in the range of 100 to 200 mm.

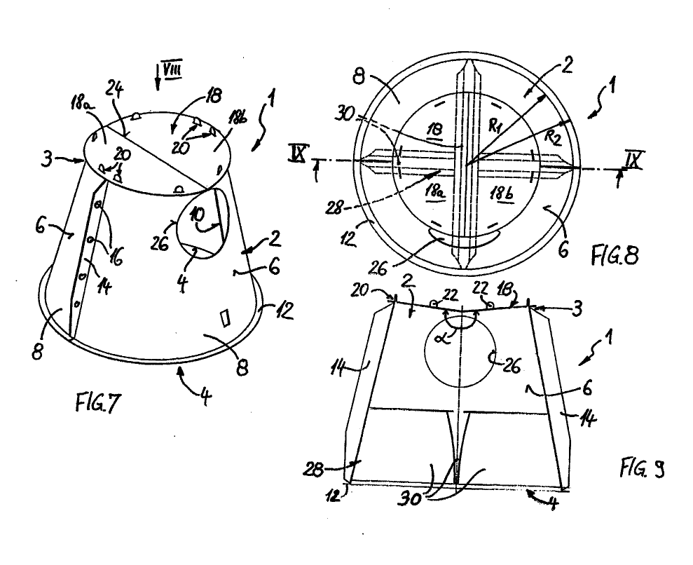

It may further be mentioned with the aid of the exemplary embodiment in accordance with FIGS. 7 to 9 that in the region of the light exit opening 4 the reflector body 2 can have an anti-glare guard 28. This also holds in principle correspondingly for all other designs. In the example illustrated, a slat insert with slats 30 running diametrically in cruciform fashion is provided as anti-glare guard 28. Alternatively or in addition, it is also possible to provide annularly, in particular coaxially, running slats. The anti-glare guard 28 or the slat insert is fastened in the peripheral wall 6 in a suitable way inside the reflector body 2 in the vicinity of the light exit opening 4.

The invention is not limited to the exemplary embodiments illustrated and described, but also comprises all designs acting equally for the purpose of the invention. It may be explicitly stressed that the exemplary embodiments are not limited to all the features in combination but that, rather, each individual partial feature can also be significant per se for the invention when detached from all the other partial features. Furthermore, the invention has also not yet so far been limited to the combination of features defined in claim 1, but can also be defined by any other desired combination of specific features of all the individual features disclosed overall.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A luminaire reflector comprising a pot-like hollow, rotationally symmetrical, frustoconical reflector body having a peripheral wall that is circularly curved in a peripheral direction and increases in diameter from a rear side up to a front light exit opening, the reflector body having an outwardly bent over, annular peripheral edge web that surrounds the light exit opening and is bounded by two circles of different radii,
wherein the peripheral wall of the reflector body is longitudinally divided into shell-like wall parts, the shell-like wall parts being selected from two, three, and four shell-like wall parts, the shell-like wall parts correspondingly curved in the shape of a circular arc in a peripheral direction,
wherein each wall part, together with a part of the annular peripheral edge web, is formed from a pre-coated sheet metal material that is strongly optically reflecting at least on the inside.

2. The luminaire reflector according to claim 1, wherein the peripheral wall is divided in a radially symmetrical fashion into similar wall parts.

3. The luminaire reflector according to claim 1, wherein the peripheral wall is diametrically divided and is composed of two shell-like wall parts.

4. The luminaire reflector according to claim 1, wherein the peripheral wall is composed of one of the following: three wall parts and four wall parts.

5. The luminaire reflector according to claim 1, wherein the wall parts are permanently interconnected in pairs in each case in a region of longitudinally running parting lines.

6. The luminaire reflector according to claim 5, wherein in the region of the parting lines, the longitudinal edge of the peripheral wall has radially outwardly bent over connecting webs that are permanently interconnected in a juxtaposed fashion.

7. The luminaire reflector according to claim 1, wherein the reflector body is closed by a cover on its rear side, which lies opposite the light exit opening and has a smaller diameter.

8. The luminaire reflector according to claim 7, wherein the cover is connected to the peripheral wall of the reflector body via latching connections.

9. The luminaire reflector according to claim 7, wherein the cover is subdivided into at least two neighboring partial surfaces via at least one bending line, the neighboring partial surfaces being aligned on the inside of the reflector body at an angle to one another that is greater or less than 180°.

10. The luminaire reflector according to claim 7, wherein the cover is substantially flat and arranged parallel to the plane of the light exit opening.

11. The luminaire reflector according to claim 1, wherein the peripheral wall of the reflector body has at least one through opening for a luminous means.

12. The luminaire reflector according to claim 7, wherein the cover has at least one through opening for a luminous means.

13. The luminaire reflector according to claim 7, the cover comprises sheet metal material that is pre-coated on the surface and is strongly optically reflecting at least on the inside.

14. The luminaire reflector according to claim 1, wherein at least one of the peripheral wall and the cover comprise at least one of the following features:
smooth on the inside and having a facet-like profile.

15. The luminaire reflector according to claim 1, wherein the wall parts of the peripheral wall have different reflection properties.

16. The luminaire reflector according to claim 7, wherein the cover has one of a circular and a polygonal outer edge, and wherein the cover has holding elements for mounting the reflector body.

17. The luminaire reflector according to claim 1, wherein the reflector body has an anti-glare guard.

18. A luminaire reflector comprising a pot-like hollow, rotationally symmetrical, frustoconical reflector body having a peripheral wall that is circularly curved in a peripheral direction and increases in diameter from a rear side up to a front light exit opening, the reflector body having an outwardly bent over, annular peripheral edge web that surrounds the light exit opening and is bounded by two circles of different radii, wherein the peripheral wall of the reflector body is continuously longitudinally divided at one peripheral site and is composed of one wall part whose longitudinal edges are connected in a region of a longitudinally running parting line, the peripheral wall being formed in one piece, together with the annular peripheral edge web, from a pre-coated sheet metal material that is strongly optically reflecting at least on the inside.

19. The luminaire reflector of claim 18, wherein the reflector body is closed by a cover on its rear side, which lies opposite the light exit opening and has a smaller diameter.

20. The luminaire reflector according to claim 19, wherein the cover is substantially flat and arranged parallel to the plane of the light exit opening.
